(19) United States
(12) Patent Application Publication
(10) Pub. No.: US 2015/0248560 A1
(43) Pub. Date: Sep. 3, 2015

(54) METHOD FOR SPECIFYING USER ACCESS RIGHTS FOR A DIGITAL DOCUMENT USING EXISTING RIGHTS MANAGEMENT POLICIES WITH MODIFICATIONS

(71) Applicant: KONICA MINOLTA LABORATORY U.S.A., INC., San Mateo, CA (US)

(72) Inventor: Rabindra Pathak, San Jose, CA (US)

(73) Assignee: KONICA MINOLTA LABORATORY U.S.A., INC., San Mateo, CA (US)

(21) Appl. No.: 14/194,641

(22) Filed: Feb. 28, 2014

(51) Int. Cl. G06F 21/60

(52) U.S. Cl. CPC G06F 21/60

(57) ABSTRACT

A digital rights management (DRM or RMS) method allows the operator of a scanner, connected to an RMS server, to associate a digital document with user access rights that are different from the rights defined by any of the existing DRM policies on the server. The method allows the operator to choose one of the existing policies on the server, and modify the user access rights by granting rights to additional users and/or removing rights of some users that would be granted by that policy, to generate modified user access rights for a document without changing any existing policies or adding new policies. The server stores the document ID, polity ID and the user access rights (modified or unmodified) in a rights association table on the server. The method is also applicable when importing documents into the DRM system from sources other than scanners.

### BACKGROUND OF THE INVENTION

1. Field of the Invention

This invention relates to digital rights management systems, and in particular, it relates to a method for specifying user access rights when creating digital documents.

2. Description of Related Art

Documents traditionally available only in hard copies are increasingly also available in digital copies. In fact many documents nowadays are prepared, generated, stored, distributed, accessed, read or otherwise used electronically in digital file formats such as the Portable Document Format (PDF). With the wide use of digital documents and digital document processing, digital rights management systems (“DRM” or “RMS”) are increasingly implemented to control user access and prevent unauthorized use of digital documents. The rights involved in using a digital document may include the right to view (or “read”) the digital document, the right to edit (or “write”) the digital document, the right to print the digital document in hard copies, the right to copy the digital document, etc. A user may access a digital document by acquiring (or being assigned) one or more of these rights.

DRM systems are generally implemented for managing users' rights to the digital documents stored in the systems. In a current DRM system, each digital document is associated with a rights management policy (or simply referred to as policy in this disclosure) that specifies which user has what rights to the document, as well as other parameters relating to access rights. Many such policies are stored in a DRM server. Typically, only a policy name is associated with the document; the content of the multiple policies (e.g. which user has what access rights) is stored on the DRM server. When a user attempts to access a document (either a document residing on a server or a document that has been downloaded or copied to the user's computer), the DRM server determines whether the user has the right to access the document in the attempted manner (view, edit, print, etc.) be referring to the content of the policy that is associated with the document.

Each document is associated with a policy when the document is created or acquired by the DRM system. In one known DRM system, a scanner device (for example, a multi-function printer (MFP) that has printing, scanning and copying functions, or a device that has only scanning function) is connected to the DRM server by a network. When an operator uses the scanner to scan a hardcopy document into a digital document, the scanner prompts the operator to specify a rights management policy to be associated with the digital document. More specifically, the scanner displays a list of pre-defined policies (by policy name or ID) for the operator to choose from; the operator is only allowed to choose one of the pre-defined policies. An example of such a system is implemented the Canon imageRUNNER ADVANCE devices, as described in a document entitled “Safeguarding information Within Documents and Devices,” available on the internet at http://www.usa.canon.com/CUSA/assets/app/pdf/ISG_Security/brochure_run_iradv_security_pdf.

### SUMMARY

The known DRM system only allows the scanner operator to choose from a list of existing rights management policies when assigning access rights to a scanned document. The operator is not able to specify user access rights other than by choosing one of the existing policies.

An object of the present invention is to provide a method and related apparatus that allow the operator to define the user access rights for a scanned document in a more flexible way.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a digital rights management system including an external device and a server connected to the external device, for defining user access rights of digital documents generated by the external device, the method including: by the external device: (a) generating a digital document by scanning a hard copy document; (b) obtaining a plurality of digital rights management policies from the server, each policy defining user access rights which specifies a plurality of users having access rights to a digital document with which the policy is to be associated; (c) displaying a list of policy IDs of the plurality of policies on a user interface panel of the external device; (d) receiving, via the user interface panel, a first operator input which selects one of the listed policies to be associated with the digital document; (e) receiving second operator inputs which either indicate no modification is requested, or indicate addition of access rights for one or more users and/or removal of access rights of one or more users; (f) generating modified user access rights based on the second operator inputs, which specifies a modified plurality of users having access rights to the digital document, and transmitting to the server the digital document, the policy ID of the selected policy and the modified user access rights; by the server: (g) receiving, from the external device, the digital document, the policy ID of the selected policy and the modified user access rights; (h) storing the document ID, the policy ID of the selected policy and the modified user access rights as an entry in a rights association table; and (i) storing the digital document.

The method may further include: (j) receiving, from a user computer, a user access request which indicates a target document ID of a document to be accessed and a user ID of the requesting user; (k) determining access permission of the requesting user based on the user access rights specified in an entry of the rights association table that contains the target document

ID without regard to user access rights defined in any policy associated with the target document ID; and (1) transmitting a reply to the user computer based on the access permission determined in step (k).

In another aspect, the present invention provides a method implemented in a device connected to a digital rights management server for defining user access rights of digital documents to be managed by the server, which includes: (a) obtaining a digital document to be managed by the server; (b) displaying a list of policy IDs of a plurality of digital rights management policies obtained from the server, each policy defining user access rights which specifies a plurality of users having access rights to any digital document with which the policy is to be associated; (c) receiving a first operator input which selects one of the listed policies to be associated with the digital document; (d) receiving second operator input which indicates addition of access rights for one or more users and/or removal of access rights of one or more users; (e) based on the second operator inputs, generating modified user access rights which specifies a modified plurality of users having access rights to the digital document; and (f) transmitting the digital document, the policy ID of the selected policy, and the modified user access rights to the server.

In another aspect, the present invention provides a method implemented in a digital rights management system server for managing user access to digital documents, which includes: (a) storing a plurality of digital rights management policies, each policy defining user access rights which specifies a plurality of users having access rights to any digital document with which the policy is to be associated; (b) receiving, from an external device, a first digital document, a first policy ID of a selected one of the policies, and modified user access rights, the modified user access rights being different from the user access rights defined in the selected policy and specifying a modified plurality of users having access rights to the first digital document; (c) associating a first document ID of the first digital document, the first policy ID, and the modified user access rights with each other in a database; and (d) storing the first digital document.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above methods.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a digital rights management (RMS or DRM) system according to an embodiment of the present invention.

FIG. 2 schematically illustrates a digital rights management method executed by a scanner and the RMS server when scanning a document.

FIGS. 3A to 3E schematically illustrate the display on the scanner during various steps of the process of FIG. 2.

FIG. 4 schematically illustrates a policy table stored in the RMS server in the system shown in FIG. 1.

FIG. 5 schematically illustrates a secondary association table stored in the RMS server in the system shown in FIG. 1.

FIG. 6 schematically illustrates a digital rights management method executed by the RMS server and a user computer when a user accesses a document.

### DETAILED DESCRIPTION OF PREFERRED EMBODIMENTS

The description herein of the structures, functions, interfaces and other relevant features, such as digital rights policies, application programming interface (API) for rights management and policies, etc., of existing DRM systems may at times incorporates, references or otherwise uses certain information, documents and materials from publicly and readily available and accessible public information, e.g., “Rights Management” (URL http://help.adobe.com/en_US/livecycle/10.0/Overview/WS92d06802c76abadb2c8525912ddcb9a ad9-7ff8.html), “Programmatically applying policies (a subsection of ‘Rights Management’)”, (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc.

Embodiments of the present invention provide a digital rights management method that allows the operator of a scanner (or other devices used to add digital documents into the DRM database) to associate a digital document with user access rights that are different from the rights defined in any of the existing policies. More specifically, the method allows the operator to choose one of the existing policies stored on the RMS server, and modify the user access rights by granting rights to additional users and/or removing rights of some users that would be granted by that policy, to generate modified user access rights for a particular digital document without changing the policy itself. For example, the operator can choose policy #2 which grants viewing right to users A, B and C only, then specifies viewing right to be granted to additional user D, while removing user C's viewing right. As a result, users A, B and D only are granted viewing right for the digital document. The method can accomplish this result without modifying the policies that are already stored on the RMS server.

While the digital rights management system and method described below are in the context of creating digital documents by a scanner, the method can be generally applied when adding documents into the DRM database by other means, such as when authoring new documents, downloading or uploading documents to the DRM system from other servers or clients, receiving documents via email, etc. Stated more generally, embodiments of the present invention provide methods for defining user access rights for documents when adding digital documents into the DRM system.

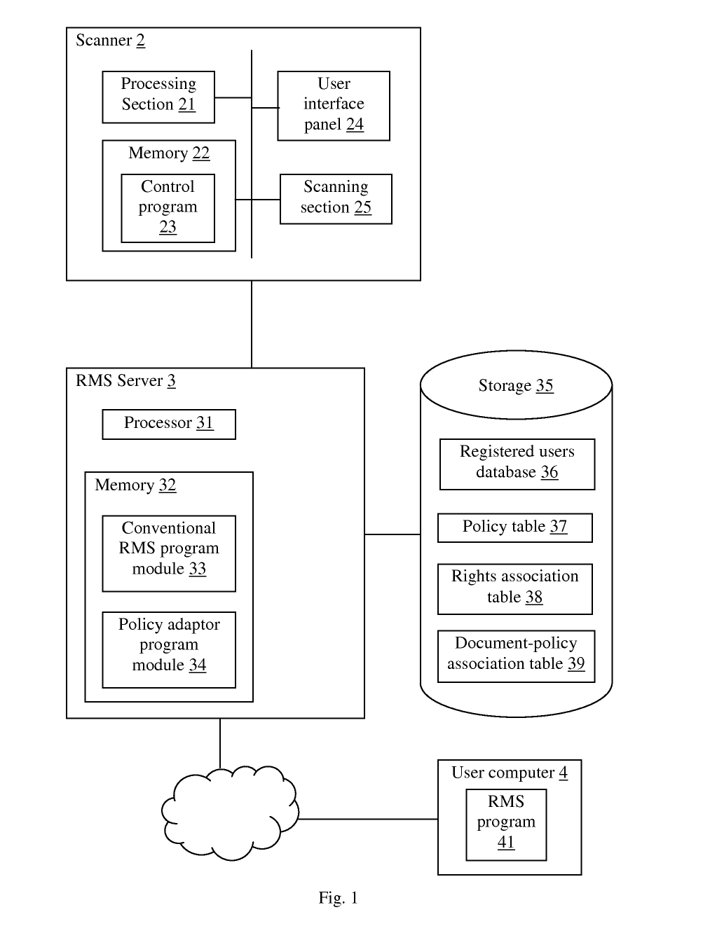

FIG. 1 schematically illustrates a digital rights management system (DRM or RMS) according to an embodiment of the present invention. The system includes a scanner device 2, a digital rights management server (RMS server) 3 connected to the scanner device, as well as a user computer 4 connected to the server 3. The scanner device 2 includes a processing section 21, a memory 22 storing a control program 23, a user interface panel 24, and a scanning section 25 which includes hardware that performs the scanning functions. The processing section 21 executes the control program 23 to control the various functions of the scanner 2, including various steps of the digital rights management method described later. The scanner 2 is connected to the RMS server 3 via a network or other type of connections. The server 3 includes a processor 31 which executes software programs stored in a memory 32 to perform various processes, including steps of the digital rights management method described later. The server 3 is connected to a storage device 35 which stores digital documents and DRM related tables and other information described later (the digital documents and the various tables may be collectively referred to as the DRM database). The storage device 35 can be deemed a part of the server 3. The user computer 4 is connected to the RMS server 3 via a network such as the Internet. The user computer 4 is installed with a rights management program 41 that cooperates with the server 3. The user computer 4 also includes a processor and memory where the program 41 is stored, but for simplicity they are not shown in FIG. 1.

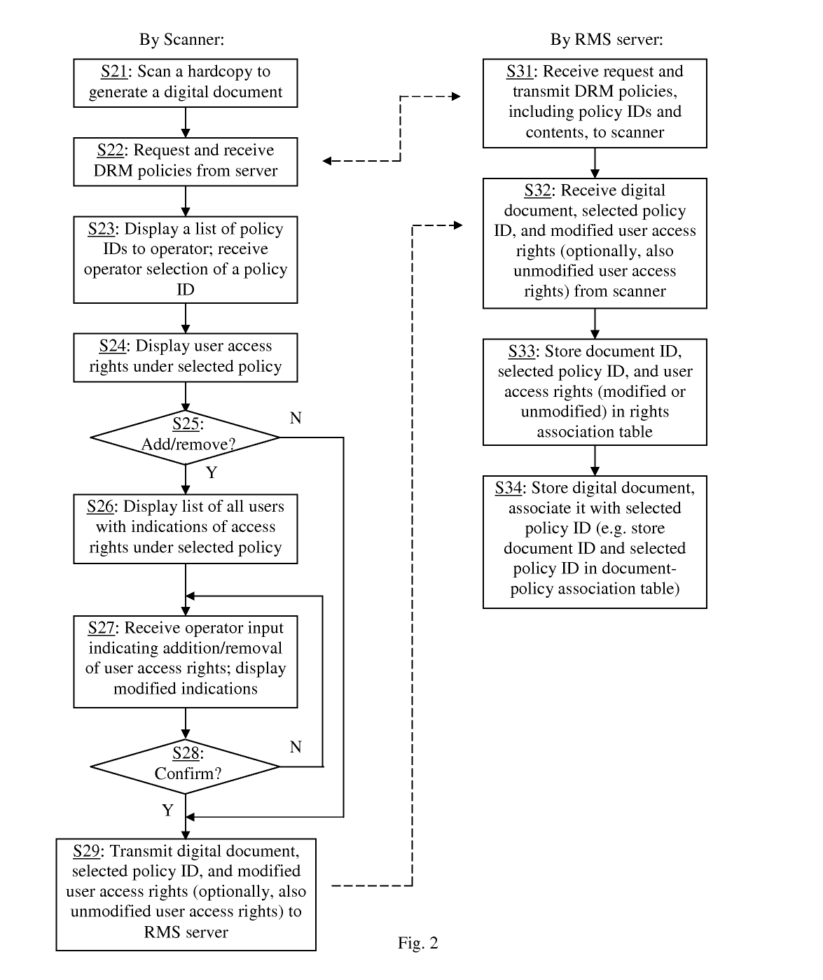

FIG. 2 schematically illustrates a digital rights management method according to an embodiment of the present invention. In the illustrated process, steps S21 to S29 are performed by the scanner 2, and steps S31 to S35 are performed by the RMS server 3. The dashed lines in FIG. 2 indicate communication between the scanner 2 and the server 3. The process on the scanner begins when an operator uses the scanner to scan a hardcopy document and request rights protection for the scanned document (step S21). In this embodiment, the scanning step, which generates a scanned digital document, is a part of step S21; alternatively, actual scanning can be performed later, e.g. just before step S29. The scanner obtains the DRM policies and a list of all registered users of the DRM system from the server (step S22). In the illustrated embodiment, the policies and the registered users list are maintained by the server 3, e.g. stored respectively in a policy table 37 and a registered users database 36 in the storage device 35, and provided to the scanner 2 upon request (step S31). In an alternative embodiment, the policies registered users list are stored on the scanner locally (and therefore steps S22 and S31 are omitted). In the latter situation, the locally stored policies and registered users list will be updated from time to time using the centrally maintained policy table on the server.

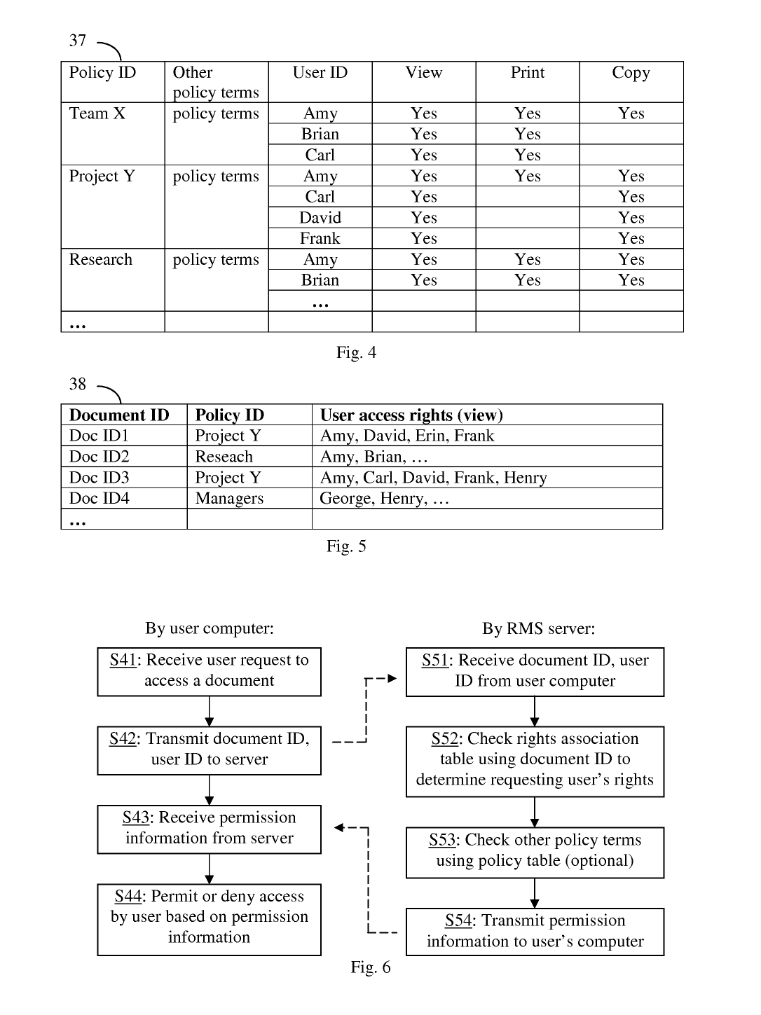

Each DRM policy has a policy ID and specifies various policy terms, including user access rights, i.e., which user is granted what rights (view, edit, print, copy, etc.), and other policy terms (optional) such as the time period the policy will be in force, other restrictions, etc. For example, in a large organization, policies can be configured to grant access rights to users within business units, users having certain job titles, etc. The policies may have user-friendly IDs (names) such as “Project X,” “Team Y,” “Managers,” etc. The user access rights within each policy will specify a list of user names and rights granted to each user. Preferably, users not granted any rights will not be listed in the policy. FIG. 4 schematically illustrates an exemplary policy table containing a number of policies.

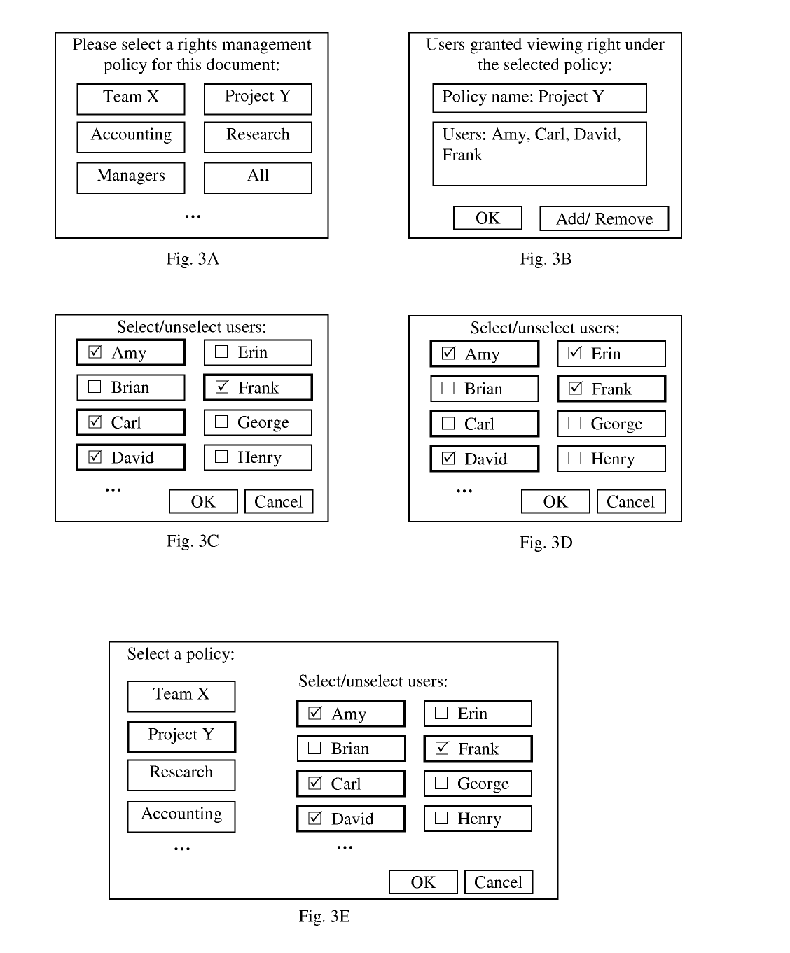

After obtaining the policies, the scanner 2 displays a list of policies (by ID) to the operator, and the operator selects one of the displayed policies (step S23). The display and selection are done by using the user interface panel 24 of the scanner, which may be a touch panel or other types of interface device. FIG. 3A schematically illustrates an exemplary display for step S23, which allows the operator to select a policy using the labeled buttons. The scanner then displays a list of users currently granted access rights under the selected policy, including an option allowing the operator to request to add/remove (i.e. modify) user rights (step S24). FIG. 3B schematically illustrates an exemplary display for step S24, showing a list of users having viewing right granted under the selected policy “Project Y”, and an “Add/Remove” button that allows the operator to request modifications. Viewing right is used in this example, but other rights may be specified as well.

If the operator requests to modify user rights (“Y” in step S25), the scanner displays a list of all registered users of the system, with indications of which users are currently granted access rights under the selected policy (step S26). This display also allows the operator to select additional users to be granted access right and/or remove rights from users that are currently granted the rights. FIG. 3C schematically illustrates an exemplary display for step S26. In this display, the names of all registered users are listed (a tool such as a scroll bar or alphabetical index may be provided when the number of users is large), with a checkbox next to each user indicating whether rights (viewing right in this example) is to be granted to that user. In addition, users originally granted rights under the selected policy are highlighted (as shown by thicker lines in this illustration).

Using the display of step S26, the operator selects and/or unselects user names (e.g. check and/or uncheck the boxes), and the display panel displays the modified selection indication interactively (step S27). FIG. 3D schematically illustrates an example of the operator's select/unselect result, where user Carl is now unselected and user Erin is now selected. In a preferred embodiment, as the operator selects and unselects users, the users that are originally granted access rights under the selected policy remain highlighted regardless of selection/unselection, so that the operator can easily see how his modified user list compares to the original user list under the selected policy. Thus, for example, in FIG. 3D, user Carl is unselected but still highlighted, and user Erin is selected but not highlighted.

When the operator is satisfied with his selections and presses the “OK” button in the display shown in FIG. 3D, the scanner displays a confirmation screen which may be similar to

FIG. 3B but now showing the modified list of users with rights, and receives a confirmation instruction from the operator (“Y” in step S28). The scanner then transmits the scanned digital document to the RMS server 3, along with the selected policy ID and the modified user access rights (step S29). The modified user access rights can be expressed as a list of users to be granted access rights, or a list of added and removed users with respect to the selected policy.

The latter approach may be more efficient because the original list of users specified in the selected policy may be long and the list of added and removed users may be relatively short.

In one embodiment, if in step S25 the operator did not request to modify the user access rights (e.g., the operator presses the “OK” button on the display of FIG. 3B) (“N” in step S25), or in step S27 the operator did not change any user access rights, then the scanner will directly transfer the scanned digital document and the selected policy ID to the server, with an indication that no modified user access rights is present (step S29). In another embodiment, the scanner transmits the user access rights to the server even if the operator did not modify any of the rights.

In one embodiment, the scanner can also directly transmit the document via email to the users that have been granted access rights to the document. This operation is sometimes referred to as “scan to email.” Appropriate processing of the scanned document, such as encryption, is applied before transmission by email. This step (not shown in FIG. 2) may be performed before or after step S29.

It is noted that in step S24, the display of user list under the selected policy (FIG. 3B) makes it convenient for the operator to decide whether he wants to modify the user access rights or not, but this display is optional. In an alternative embodiment, steps S24 and S25 are omitted;

instead, after the operator selects a policy ID in step S23 (using the screen shown in FIG. 3A), the scanner directly proceeds to step S26 to display the user rights modification screen e.g. FIG. 3C. Likewise, the confirmation step S28 can also be omitted.

In another alternative embodiment, the display of a list of policies and a list of users are combined on the same display screen, and the displays and operator inputs for steps S23, S26, and S27 can be done using the same screen. An example of which is shown in FIG. 3E. In this embodiment, the initial display of step S23 has a list of policies, but no policy is highlighted; and a list of users is presented on the same screen, but no user is selected and no user is highlighted. A tool such as a scroll bar or alphabetical index may be provided when the number of policies or number of users is large. Then, the operator selects a policy, e.g. by clicking on one of the listed policies. Steps S24 and S25 are omitted. Step S26 displays indications of which users have access right under the selected policy, e.g. by checking the checkboxes next to the names for these users, and also highlights these users. FIG. 3E shows an exemplary display of this step, where the policy “Project Y” has been selected (it is highlighted), and users Amy, Carl, David and Frank are shown as being granted rights under this policy. Then, the operator performs addition/removal of users, by selecting/unselecting users from the displayed list, e.g. by checking/unchecking the corresponding checkboxes nest to the users. The highlight for the users that are originally granted access rights by the selected policy will remain unchanged regardless of the addition and removal of users. Thus, for example, if the operator unselects user Carl and selects user Erin, the user list on the right hand side of FIG. 3E will resemble that shown in FIG. 3D, with user Carl unselected but still highlighted and user Erin selected but not highlighted. After the operator is satisfied with the user selection, the operator can confirm it and proceed to the next step by clicking the OK button (step S28).

On the server side, after it receives the data transmitted from the scanner 2 (digital document, the selected policy ID, and the modified user access rights if present) (step S32), the server 3 creates an entry in a rights association table 38 that associates a unique ID of the document with the ID of the selected policy and the user access rights (either modified or unmodified) (step S33). An entry is created for each document received from the scanner. In the case where the scanner always transmits the user access rights to the server regardless of whether the operator has modified them, the user access rights received from the scanner will be used to create the entry in the rights association table 38. In the case where the scanner does not transmit the user access rights when the operator has not modified them, the server can copy the user access rights from the selected policy in the policy table 37 when creating the entry in the rights association table.

FIG. 5 schematically illustrates an exemplary structure of the rights association table; in this example the user access rights are expressed as a list of users to be granted the access right.

Only viewing right is shown as an example in FIG. 5, but other rights (edit, print, copy, etc.) can also be specified in the rights association table as appropriate.

The document itself is stored, e.g. in the storage device 35 (step S34). In addition to the rights association table 38, a document-policy association table 39 may also be maintained in the DRM system. Each entry of the document-policy association table contains the document ID and the policy ID of the associated policy. Such document-policy association tables are used in conventional DRM systems, and therefore can continue to be maintained although it does not serve any necessary function in embodiments of the present invention. In addition to or in lieu of the document-policy association table, the policy ID may be included as a part of the metadata of the document to associate the document with the policy.

As mentioned earlier, one reason for continuing to use the document-policy association table 39 is that some popular existing DRM system already uses such a table to perform various functions. Thus, embodiments of the present invention can be implemented by providing an additional program module (such as a plug-in), e.g. a policy adaptor program module 34 shown in FIG. 1, for the existing DRM system on the server 3; the additional program module 34 will create and maintain the rights association table 38, while the existing program modules of the DRM system (shown as conventional RMS program module 33 in FIG. 1) will maintain the document-policy association table 39 and perform other functions. In such an implementation, steps S32 and S33 are performed by the policy adaptor module 34 and step S34 is performed by the conventional RMS module 33. The policy adaptor module 34 is located before the conventional RMS module 33; it intercepts the data transmitted from the scanner 2 and pass appropriate information to the conventional RMS module.

Of course, all steps on the server can be integrated into one program module of the DRM system.

As mentioned earlier, the DRM methods described here can be applied when uploading or downloading digital documents to the server from other servers or clients. In such a situation, steps S23 to S28 will be performed by the server itself.

After a digital document managed by the DRM system is distributed to users, when a user attempts to access it, e.g. to view it on his computer, the digital rights management program 41 on the user's computer 4 cooperates with the RMS server 3 to facilitate the access. FIG. 6 schematically illustrates such a process according to another embodiment of the present invention. In this process, steps S41 to S44 are performed by the user computer 4 and steps S51 to S53 are performed by the server 3. Dashed lines indicate communication between the server and user computer.

When the user requests to access the document residing on his computer 4 (step S41), the user computer transmits to the server the document ID of the document to be accessed (the target document ID) and the user ID of the requesting user (step S42). Upon receiving that information (step S51), the server first checks the rights association table 38 using the target document ID to determine whether the requesting user has access rights to the target document (step S52).

Because the user access rights for each document is fully specified in the rights association table, the server does not need to refer to the policy table 37 or the document-policy association table 39 to determine the requesting user's access rights. However, optionally, the server can still checks the policy table 37 (after obtaining the selected policy ID from the rights association table) to determine whether other terms of the associated policy will affect the user's access permission (step S53). In such a situation, however, the user access rights defined under the associated policy will not control; rather, the rights defined in the rights association table controls.

Based on the determination in steps S52 and S53, the server transmits to the user computer permission information indicating whether or not the requesting user is permitted to access the document (step S54). Based on the received permission information (step S43), the user computer permits or denies access to the document by the user (step S44).

One implementation of the process of FIG. 6 uses two program modules on the server 3, namely the conventional RMS program module 33 and policy adaptor program module 34 as shown in FIG. 1; in this case, step S51 and S52 are performed by the policy adaptor program module 34 while step S53 is performed by the conventional RMS program module 33. The policy adaptor module 34 intercepts the data transmission from the user computer and passes appropriate information on to the conventional RMS module 33.

The digital rights management methods according to embodiments of the present invention have the following advantages: It provides the flexibility to utilize existing policies while allowing the operator to add or remove users when granting access rights to the document. Existing DRM policies do not need to be altered and new policies do not need to be created in order to create modified user access rights. In addition, it allows different documents to have different user access rights even when they are associated with the same policy; in other words, the user access rights specified in the associated policy can be overridden by the modified user access rights that is document specific.

It will be apparent to those skilled in the art that various modification and variations can be made in the digital rights management system and method of the present invention without departing from the spirit or scope of the invention. Thus, it is intended that the present invention cover modifications and variations that come within the scope of the appended claims and their equivalents.

What is claimed is:

1. A method implemented in a device connected to a digital rights management server for defining user access rights of digital documents to be managed by the server, comprising:
(a) obtaining a digital document to be managed by the server;
(b) displaying a list of policy IDs of a plurality of digital rights management policies obtained from the server, each policy defining user access rights which specifies a plurality of users having access rights to any digital document with which the policy is to be associated;
(c) receiving a first operator input which selects one of the listed policies to be associated with the digital document;
(d) receiving second operator input which indicates addition of access rights for one or more users and/or removal of access rights of one or more users;
(e) based on the second operator inputs, generating modified user access rights which specifies a modified plurality of users having access rights to the digital document; and
(f) transmitting the digital document, the policy ID of the selected policy, and the modified user access rights to the server.

2. The method of claim 1, wherein step (a) includes scanning a hard copy document to generate the digital document.

3. The method of claim 1, further comprising:
(h) obtaining a second digital document to be managed by the server;
(i) displaying a list of policy IDs of a plurality of digital rights management policies;
(j) receiving a third operator input which selects a second one of the listed policies to be associated with the second digital document;
(k) receiving a fourth operator input indicating that no change to user access rights defined by the selected second policy is requested; and
(l) transmitting the digital document, the policy ID of the selected second policy, and the user access rights defined by the selected second policy to the server.

4. The method of claim 1, further comprising, after step (c) and before step (d):
(g) based on the policy selected by the first operator input, displaying a list of all users registered with the server and indications which indicate whether or not each user has access rights as defined by the selected policy.

5. The method of claim 4, wherein step (g) includes displaying a highlight for each user that has access rights as defined by the selected policy, the method further comprising, after step (d), modifying the display of step (g) by changing the indications to indicate whether each user has access rights based on the second operator inputs received in step (d), without changing the highlights.

6. A method implemented in a digital rights management system server for managing user access to digital documents, comprising:
(a) storing a plurality of digital rights management policies, each policy defining user access rights which specifies a plurality of users having access rights to any digital document with which the policy is to be associated;
(b) receiving, from an external device, a first digital document, a first policy ID of a selected one of the policies, and modified user access rights, the modified user access rights being different from the user access rights defined in the selected policy and specifying a modified plurality of users having access rights to the first digital document;
(c) associating a first document ID of the first digital document, the first policy ID, and the modified user access rights with each other in a database; and
(d) storing the first digital document.

7. The method of claim 6, wherein step (c) comprises:
storing the first document ID, the first policy ID, and the modified user access rights received from the external device as an entry in a rights association table of the database.

8. The method of claim 7, further comprising:
(e) receiving, from the external device, a second digital document and a second policy ID of a second selected one of the policies, without any modified user access rights;
(f) obtaining user access rights defined by the second selected policy from the stored policies;
(g) storing the second document ID, the second policy ID, and user access rights defined by the second selected policy as an entry in the rights association table; and
(h) storing the second digital document.

9. The method of claim 7, further comprising:
(i) receiving, from a user computer, a user access request which indicates a target document ID of a document to be accessed and a user ID of the requesting user;
(j) determining access permission of the requesting user based on the user access rights specified in an entry of the rights association table that contains the target document ID without regard to user access rights defined in any policy associated with the target document ID; and
(k) transmitting a reply to the user computer based on the access permission determined in step (j).

10. A method implemented in a digital rights management system including an external device and a server connected to the external device, for defining user access rights of digital documents generated by the external device, the method comprising:
by the external device:
(a) generating a digital document by scanning a hard copy document;
(b) obtaining a plurality of digital rights management policies from the server, each policy defining user access rights which specifies a plurality of users having access rights to a digital document with which the policy is to be associated;
(c) displaying a list of policy IDs of the plurality of policies on a user interface panel of the external device;
(d) receiving, via the user interface panel, a first operator input which selects one of the listed policies to be associated with the digital document;
(e) receiving second operator inputs which indicate addition of access rights for one or more users and/or removal of access rights of one or more users;
(f) generating modified user access rights based on the second operator inputs, which specifies a modified plurality of users having access rights to the digital document, and transmitting to the server the digital document, the policy ID of the selected policy and the modified user access rights;
by the server:
(g) receiving, from the external device, the digital document, the policy ID of the selected policy and the modified user access rights;
(h) storing the document ID, the policy ID of the selected policy and the modified user access rights as an entry in a rights association table; and
(i) storing the digital document.

11. The method of claim 10, further comprising:
(j) receiving, from a user computer, a user access request which indicates a target document ID of a document to be accessed and a user ID of the requesting user;
(k) determining access permission of the requesting user based on the user access rights specified in an entry of the rights association table that contains the target document ID without regard to user access rights defined in any policy associated with the target document ID; and
(l) transmitting a reply to the user computer based on the access permission determined in step (k).

12. The method of claim 10, further comprising, after step (d) and before step (e):
(m) based on the policy selected by the first operator input, displaying a list of all users registered with the server and indications which indicate whether each user has access rights as defined by the selected policy.

13. The method of claim 12, wherein step (m) includes displaying a highlight for each of the plurality of users that have access rights as defined by the selected policy, the method further comprising, after step (e), modifying the display of step (m) by changing the indications to indicate whether each user has access rights based on the second operator inputs received in step (e), without changing the highlights.
